(19) United States
(12) Patent Application Publication
(10) Pub. No.: US 2016/0211080 A1
(43) Pub. Date: Jul. 21, 2016

(54) ANODE BODY FOR TUNGSTEN CAPACITOR AND METHOD FOR MANUFACTURING THE SAME

(71) Applicant: SHOWA DENKO K.K., Tokyo (JP)

(72) Inventors: Kazumi NAITO, Tokyo (JP); Shouji YABE, Tokyo (JP)

(73) Assignee: SHOWA DENKO K.K., Tokyo (JP)

(21) Appl. No.: 14/410,364

(22) PCT Filed: Apr. 11, 2013
(86) PCT No.: PCT/JP2013/060898

§ 371 Date: Dec. 22, 2014

(30) Foreign Application Priority Data
Jun. 22, 2012 (JP) 2012-140965

(51) Int. Cl. H01G 9/042; H01G 9/052; H01G 9/00; H01G 9/15

(52) U.S. Cl. CPC H01G 9/042; H01G 9/15; H01G 9/0525; H01G 9/0029

(57) ABSTRACT

Disclosed is (1) an anode body for a capacitor including a tungsten sintered body containing 15 to 3,000 ppm by mass of phosphorus element; (2) a method for producing an anode body for a capacitor which includes producing a molded body of tungsten powder in which a phosphorus source is mixed and sintering the molded body to thereby incorporate 15 to 3,000 ppm by mass of phosphorus element in the anode body; (3) a capacitor element including the anode body; and (4) a capacitor including the capacitor element.

### TECHNICAL FIELD

The present invention relates to an anode body of a capacitor comprising a tungsten sintered body, the method of manufacturing the same, a capacitor element using the anode body, and a capacitor having the capacitor element.

### BACKGROUND ART

An electrolytic capacitor is composed of a conductor (an anode body) as one electrode, a dielectric layer formed in the surface layer of the electrode, and the other electrode (semiconductor layer) provided thereon. As an example of such a capacitor, an electrolytic capacitor has been proposed, which capacitor is produced by anodically oxidizing an anode body for capacitors comprising a sintered body made of a valve-acting metal powder which can be anodized such as tantalum, niobium and aluminum to form a dielectric layer made of the oxide of the metal on an inner layer of fine pores and on the outer surface layer of the electrode, polymerizing a semiconductor precursor (monomer for conductive polymer) on the dielectric layer to form a semiconductor layer comprising a conductive polymer, and forming an electrode layer on a predetermined part on the semiconductor layer.

A capacitor element employing a sintered body of tungsten powder as an anode body, on the surface of which a dielectric layer is formed by the electrolytic formation, can attain a larger capacitance compared to the electrolytic capacitor using the tantalum powder having the same particle diameter obtained with the same formation voltage by employing the anode body of the same volume, however, also having a large leakage current. In order to solve the leakage current (LC) problem, a capacitor using the alloy of tungsten and other metals has been studied, but it was not enough (JP-A-2004-349658 (U.S. Pat. No. 6,876,083 B2); Patent Document 1).

### PRIOR ART

### Patent Document

Patent Document 1: JP-A-2004-349658

### DISCLOSURE OF THE INVENTION

### Problems to be Solved by the Invention

It was found that the capacitor having an anode body comprising a tungsten sintered body (hereinafter may be referred to as a “tungsten capacitor”) not only has a large LC right after the capacitor was produced (hereinafter may be referred to as an “initial LC”) but also has a property that the leakage current increases when it is left to stand at room temperature (hereinafter may be referred to as “leave-to-stand characteristics”). Such characteristics are not observed in a solid electrolytic capacitor element using an anode body comprising a tantalum or niobium sintered body.

Accordingly, an object of the present invention is to provide an anode body which can remedy the above-mentioned problem of the LC characteristics in an electrolytic capacitor having an anode body comprising a tungsten sintered body.

### Means to Solve the Problem

As a result of intensive studies to solve the above-mentioned problem, the present inventors have found that when the phosphorus element is incorporated in the anode body of a capacitor element in an amount within a specific range, it not only can suppress the initial LC but also can diminish the leave-to-stand characteristics, especially can suppress the rise in the LC value of the capacitor element, and accomplished the present invention.

That is, the present invention relates to the anode body of a capacitor, the production method of the same, the capacitor element using the anode body, and a capacitor having the capacitor element as follows.
[1] An anode body for a capacitor comprising a tungsten sintered body containing 15 to 3,000 ppm by mass of phosphorus element.
[2] The anode body as described in [1] above, further comprising 7 mass % or less of silicon element.
[3] The anode body as described in [2] above, wherein the silicon element is contained as tungsten silicide.
[4] The anode body as described in any one of [1] to [3] above, in which an oxygen element content is 8 mass % or less.
[5] The anode body as described in any one of [1] to [4] above, in which a nitrogen element content is 0.5 mass % or less.
[6] The anode body as described in any one of [1] to [5] above, in which a boron element content is 0.1 mass % or less.
[7] The anode body as described in any one of [1] to [6] above, in which each content of impurity elements other than phosphorus, silicon, boron, oxygen and nitrogen is 0.1 mass % or less.
[8] The anode body for a capacitor as described in any one of [1] to [7] above, in which each amount of impurity elements other than silicon, nitrogen, boron, oxygen, phosphorus, tantalum and niobium is 1,000 ppm by mass or less.
[9] A method for producing an anode body comprising phosphorus element for a capacitor in a method for producing an anode body for a capacitor comprising sintering a molded body of tungsten powder, which method comprises producing a molded body of tungsten powder in which a phosphorus source is mixed and sintering the molded body to thereby incorporate 15 to 3,000 ppm by mass of phosphorus element in the anode body.
[10] The method for producing an anode body for a capacitor as described in [9] above, wherein the phosphorus source is selected from elemental phosphorus, phosphoric acid, phosphate and organic phosphorus compound.
[11] The method for producing an anode body for a capacitor as described in [9] or [10] above, wherein the tungsten powder contains at least one element selected from a group consisting of silicon, nitrogen, oxygen and boron.
[12] A capacitor element comprising an anode body described in any one of [1] to [8] above or an anode body obtained by the method described in any one of [9] to [11] above.
[13] A capacitor comprising the capacitor element described in [12] above.

### Effects of the Invention

The LC characteristics (particularly leave-to-stand characteristics) of a tungsten capacitor element can be improved by using an anode body for a capacitor comprising a tungsten sintered body which contains 15 to 3,000 ppm by mass of phosphorus element.

### MODE FOR CARRYING OUT THE INVENTION

The anode body for a capacitor comprising a tungsten sintered body of the present invention contains phosphorus element in an amount of 15 to 3,000 ppm by mass, preferably 20 to 2,100 ppm by mass, more preferably 50 to 2,000 ppm by mass.

When the content of phosphorus element in the anode body is less than 15 ppm by mass, it is difficult to improve the leave-to-stand characteristics of the capacitor element produced thereof. When the content of phosphorus element in the sintered body exceeds 3,000 ppm by mass, it is difficult to reduce the initial LC of the capacitor element.

There is no particular limit on the timing of making the anode body to contain 15 to 3,000 ppm by mass during the process of producing the anode body, and examples of the methods include (1) a method of producing a molded body of tungsten powder in which a phosphorus source is mixed; and sintering the molded body to thereby incorporate phosphorus element in the anode body and (2) a method of placing a phosphorus source in the furnace for sintering the molded body of tungsten powder to thereby incorporate phosphorus element in the anode body.

In order to make the phosphorus element content in the anode body fall within the above-mentioned range, it is possible to incorporate phosphorus element in several batches at any point in the methods of (1) and (2). Method (1) is preferable because phosphorous element is incorporated in good yield, an anode body which contains phosphorus element in an amount nearly equal to that of the phosphorus source mixed in the tungsten powder can be obtained, and the phosphorus element amount in the anode body can be easily controlled.

Examples of a phosphorus source include not only phosphorus element but also a compound containing phosphorus element such as phosphoric acid, phosphate and an organic phosphorus compound. Phosphorus may be made into a solution by adding an appropriate solvent and mixed into tungsten powder.

The anode body of the present invention may contain impurities other than phosphorus element within a range which does not affect the properties of a capacitor to be obtained. Particularly, it is preferable that the anode body contains components which can further improve the capacitor properties as described later.

A commercially-available tungsten powder may be used in the present invention. More preferable tungsten powder having a smaller particle diameter can be obtained by, for example, pulverizing the tungsten trioxide powder under hydrogen atmosphere; or reducing the tungstic acid, salt thereof (ammonium tungstate and the like) and tungsten halide using a reducing agent such as hydrogen and sodium, and appropriately selecting the reducing conditions. Also, the tungsten powder can be obtained by reducing the tungsten-containing mineral directly or through several steps and by selecting the reducing conditions.

Examples of more preferable tungsten powder include a finely-powdered tungsten powder obtained by dispersing a commercially-available tungsten powder in an aqueous solution containing an oxidizing agent (such as hydrogen peroxide and ammonium persulfate) to form an oxide film on the particle surface of the tungsten powder and removing the oxide film with an alkaline aqueous solution.

The tungsten powder used in the present invention contains at least one element selected from silicon, nitrogen, oxygen and boron. Particularly, the tungsten powder in which the silicon element exists as tungsten silicide at least on a part of the surface of the tungsten powder is preferable.

The tungsten powder in which a part of the particle surface is silicified can be obtained by, for example, mixing the silicon powder well into the tungsten powder and allowing the mixture to react by heating generally at a temperature of 1,100 C.° or higher and 2,600 C.° or lower under reduced pressure of 10⁻¹ Pa or less. In the case of using this method, the silicon powder reacts with the tungsten from the surface of the tungsten particles and tungsten silicide such as W₅Si₃ is formed and localized generally within 50 nm from the surface layer of the tungsten particles. Hence, the core of the primary particles remains as a highly-conducting metal, which suppresses the equal serial resistance of the anode body produced using the tungsten powder, which is preferable. The tungsten silicide content can be adjusted by the silicon amount to be added. The silicon content of the tungsten powder of the present invention is preferably 7 mass % or less, more preferably 0.05 to 7 mass %, and particularly preferably 0.2 to 4 mass %. The tungsten powder containing silicon within the above-mentioned range is a preferable powder for use in the electrolytic capacitors, imparting better LC characteristics to the capacitors.

As an example of the method for allowing nitrogen element to be contained in tungsten powder, there is a method of placing the tungsten powder at 350 to 1,500° C. under reduced pressure (generally 1 Pa or less) of a nitrogen gas atmosphere for from one minute to ten hours.

Nitrogen element may be incorporated in a sintered body material or a sintered body later under the similar conditions as in the case of incorporating nitrogen in tungsten powder. Thus, the timing of adding nitrogen element is not specified but it is preferable to add nitrogen element in an early stage of the production process. It can prevent excessive oxidation of the powder when the powder is handled in air.

It is preferable to allow nitrogen element to remain in the anode body in an amount of 0.5 mass % or less, more preferably 0.01 to 0.5 mass %, still more preferably 0.05 to 0.3 mass %. When nitrogen element is added to the tungsten powder, for example, the amount of nitrogen element in the tungsten powder may be adjusted to about the same amount to twofold amount of the target nitrogen content in the anode body as a measure. That is, a preliminary test is to be performed to adjust the content of nitrogen element in the tungsten powder to 1 mass % or less so as to attain the above-mentioned preferable nitrogen content in an anode body.

As an example of the method for allowing boron element to be contained in tungsten powder, there is a method of placing the boron element or a boron-containing compound as a boron source when granulating the tungsten powder as described later. It is preferable to add the boron source so that the boron content in the obtained anode body may be preferably 0.001 to 0.1 mass %, more preferably 0.01 to 0.1 mass %. Good LC characteristics can be attained when the boron content is within the above-mentioned range.

The content of oxygen element in the tungsten powder is preferably 8 mass % or less, more preferably 0.05 to 8 mass %, and still more preferably 0.08 to 1 mass %.

As a method for controlling the content of oxygen element within the above range, nitrogen gas containing oxygen is introduced when the powder is taken out from a high temperature vacuum furnace at the time of performing a step of adding silicon element and/or nitrogen element to tungsten powder using a high temperature vacuum furnace, as mentioned above. In case that the temperature at the time of being taken out from the high temperature vacuum furnace is lower than 280° C., oxygen is introduced in preference to nitrogen in the tungsten powder. By feeding the gas gradually, a predetermined oxygen element content can be obtained. By making each of the tungsten powders have a predetermined oxygen element content in advance, it is possible to reduce the deterioration due to the irregular excessive oxidation during the subsequent processes for producing anode bodies for capacitors using the powder. In cases where the oxygen element content is within the above-mentioned range, the LC characteristics of the produced electrolytic capacitors can be kept better. In the case when nitrogen is not introduced in this process, an inert gas such as argon and helium may be used instead of the nitrogen gas.

When tantalum or niobium is contained in the anode body of the present invention, it decreases the capacitance in some cases. Hence it is preferable to control the amount of tantalum and niobium to 25 mass % or less in the anode body. Still, they can be suitably used as an anode lead wire since they scarcely degrade the LC characteristics.

To attain better LC characteristics, it is preferable to keep the content of each of impurity elements in the anode body other than silicon, nitrogen, boron, oxygen, tantalum and niobium to 1,000 mass ppm or lower.

The tungsten powder used in the present invention may be in a form of granulated powder. Granulated powder is preferable due to its good flowability and easy operability for molding or the like. The granulated powder further may be the one in which the fine pore distribution is adjusted in the manner as JP-A-2003-213302 discloses on the case of a niobium powder.

The granulated powder can also be obtained by adding at least one member of the liquid such as water and liquid resin to the non-granulated tungsten powder (hereinafter may be referred to as “primary powder”) so as to be made into the granules having an appropriate size; and sintering the granules by heating under reduced pressure. The reduced-pressure condition to obtain easy-handling granulated granules (for example, at 1 kPa or less under non-oxygen gas atmosphere such as hydrogen) and the high temperature standing condition (for example, from 1,100° C. to 2,600° C. for 0.1 to 100 hours) can be determined by a preliminary experiment. If there are no agglomerations of the granules with each other after the sintering, there is no need for pulverization.

Such granulated powder can be classified by a sieve into particles of a similar diameter. The volume average particle diameter (hereinafter referred to as an “average particle diameter” unless otherwise noted) within a range of preferably 50 to 200 μm, more preferably 100 to 200 μm, is suitable because the powder can smoothly flow from the hopper of the molding machine to a mold.

The primary powder having a volume average primary particle diameter of 0.1 to 1 μm, preferably 0.1 to 0.3 μm can increase the capacitance of the electrolytic capacitor, particularly when the capacitor is produced from the granulated powder thereof.

When obtaining such a granulated powder, it is favorable to make the granulated powder so as to have a specific surface area (by BET method) of preferably 0.2 to 20 m²/g, more preferably 1.5 to 20 m²/g, by controlling the above-mentioned primary particle diameter because it can further increase the capacitance of the electrolytic capacitor.

In the present invention, a lead is provided to an anode body of a capacitor by implanting a valve-acting metal wire or a valve-acting metal foil at the time of molding tungsten powder or by welding the above-mentioned wire or foil to be fixed to the anode body after sintering. Subsequently, a capacitor element is obtained by forming a dielectric layer on an inner surface layer of fine pores and an outer surface layer of the tungsten anode body containing phosphorus, forming a semiconductor layer on the dielectric layer, and further forming an electrode layer on the semiconductor layer.

As the above-mentioned dielectric layer, preferred is a dielectric layer obtained by the chemical formation in the electrolytic solution comprising nitric acid or an oxygen-containing oxide (such as potassium persulfate) as electrolyte. Generally, a capacitor comprising such a dielectric layer becomes an electrolytic capacitor.

Examples of the semiconductor layer to be formed on the dielectric layer include a manganese dioxide layer and a conductive polymer layer. Among these, a conductive polymer layer having high conductivity is preferable. The type of the conductive polymers for a solid electrolytic capacitor element and the method for making the polymer into a semiconductor layer are heretofore known. For example, a semiconductor precursor (at least one kind selected from a monomer compound having a pyrrol, thiophene or aniline skeleton and various derivatives thereof) is subjected to multiple polymerization reactions to form a semiconductor layer comprising a conductive polymer and having a desired thickness. The anode body, on which a dielectric layer and a semiconductor layer are sequentially formed by the method may be used as a capacitor element as it is. Preferably, an electrode layer comprising a carbon layer and a silver layer being sequentially laminated on the above-mentioned semiconductor layer is provided on the semiconductor layer to form a capacitor element in order to improve electric contact with an external lead (e.g. lead frame). Generally, a capacitor comprising the above semiconductor layer becomes a solid electrolytic capacitor.

### EXAMPLES

The present invention is described below by referring to Examples and Comparative Examples, but the present invention is not limited thereto.

In the present invention, the measurement of the average particle diameter and elemental analysis were carried out by the methods described below.

The particle diameter was measured by using HRA9320-X100 manufactured by Microtrac Inc. and the particle size distribution was measured by the laser diffraction scattering method. A particle size value (D₅₀; μm) when the accumulated volume % corresponded to 50 volume % was designated as the average particle size.

For the element contents, ICP emission spectrometry was performed by using ICPS-8000E manufactured by Shimadzu Corporation.

### Examples 1 to 9 and Comparative Examples 1 to 5

After oxidizing a commercially-available tungsten powder having an average particle diameter of 0.6 μm by stirring it with ammonium persulfate in water to form an oxide layer on the particle surface, the powder was immersed in aqueous sodium hydroxide solution having a nominal concentration to remove the oxide layer, and tungsten powder having an average particle diameter of 0.4 μm was obtained. A phosphorus compound shown in Table 1 was mixed with the tungsten powder, and after removing the water as a solvent at 125° C. under reduced pressure, the mixture was heated in vacuum at 1,450° C. for 30 minutes. The mixture was cooled to room temperature and taken out, and agglomerates were pulverized with a hammer mill to obtain granulated powder having an average particle diameter of 95 μm (26 to 136 μm).

The granulated powder was molded with TAP2 molding machine manufactured by Seiken Co., Ltd. A tantalum wire of 0.29 mmφ was implanted to serve as an anode lead. The molded body was sintered in vacuum at 1,530° C. for 20 minutes to obtain 500 pieces of sintered bodies (anode bodies) per example, which has a size of 1.0×1.5'4.4 mm (on which a lead wire was implanted on the 1.0×1.5 mm face). The mass of the anode body excluding the lead wire was 61±3 mg. The phosphorus element concentration in the anode body is also shown in Table 1.

The sintered body was subjected to chemical conversion in a chemical conversion solution (a 3 mass % potassium persulfate aqueous solution) provided with a lead wire of the sintered body as an anode and a separately-provided electrode as a cathode at 50° C. with 13 V for six hours. The sintered body was washed with water, washed with ethanol and dried at 190° C. for 30 minutes to thereby form a dielectric layer on the sintered body and a part of the lead wire.

Next, the anode body after the chemical conversion was immersed in an ethanol solution of 10 mass % ethylenedioxythiophene, pulled out of the solution and immersed in a separately-prepared aqueous solution of 10 mass % toluenesulfonic acid iron and reacted at 60° C. The series of the operations was repeated three times. Furthermore, after immersing the anode body in an ethanol solution of 10 mass % of ethylenedioxythiphene monomer, the anode body was immersed in a separately-prepared solution of 70 parts by mass of water and 30 parts by mass of ethylene glycol in which oversaturated ethylenedioxythiophene and 3 mass % of anthraquinone sulfonic acid are dissolved, and electrolytic polymerization was performed at room temperature with a current value of 60 μA/anode piece for 60 minutes. After the sintered body was pulled up from the solution, washed with water, washed with ethanol and dried at 80° C., a post chemical conversion was carried out in the above-mentioned chemical conversion solution with 9 V for 15 minutes. The series of the operation of immersion in the ethanol solution of the monomer, electrolytic polymerization and post chemical conversion was repeated six times in total to form a semiconductor layer. The second to third electrolytic polymerization and the fourth to sixth electrolytic polymerization were performed with a current value of 70 μA/anode piece and 80 μA/anode piece, respectively.

Subsequently, a carbon layer and a silver layer obtained by solidifying a silver paste were sequentially laminated on the semiconductor layer excluding the face in which a lead wire was implanted, to thereby produce 128 pieces of solid electrolytic capacitor elements per example.

The anode bodies of Examples 6 to 9 and Comparative Example 5 contained 40 to 751 ppm by mass of nitrogen element (Example 6: 40 ppm by mass, Example 7: 81 ppm by mass, Example 8: 375 ppm by mass, Example 9: 593 ppm by mass, Comparative Example 5: 751 ppm by mass) other than phosphorus.

### Example 10

Tungsten granulated powder was produced in the same way as in Example 3 except that boric acid was added at the same time with phosphoric acid, and after that, a solid electrolytic capacitor element was produced in the same way as in Example 3. The obtained tungsten granulated powder contained 529 ppm by mass of boron other than phosphorus.

### Example 11

Tungsten granulated powder was produced in the same way as in Example 3 except that when the temperature of the tungsten powder was lowered to 60° C. before it was cooled to room temperature and taken out to be pulverized with a hammer mill, argon gas mixed with oxygen and adjusted to have the oxygen concentration of 2,000 ppm by volume was introduced to oxidize the agglomerates and they were cooled to room temperature. After that, solid electrolytic capacitor element was produced in the same way as in Example 3. The obtained tungsten granulated powder contained 3,600 ppm by mass of oxygen other than phosphorus. It was confirmed by ICP emission spectrometry that the concentration of each of impurity metal elements other than tungsten, phosphorus and oxygen was 1,000 ppm by mass or less.

### Examples 12 to 13

Powder having composition of tungsten and tantalum was produced by mixing well 80 parts by mass of tungsten powder obtained in Example 3 to which phosphoric acid was added and 20 mass % of tantalum powder of Reference Example 1 or 2, and a solid electrolytic capacitor element was produced in each example in the same way as in Example 1 to evaluate the leave-to-stand characteristics.

### Reference Examples 1 to 2

In each example, 128 pieces of tantalum solid electrolytic capacitor elements were produced in each example in the same way as in Example 4 and Comparative Example 1, respectively except that:
tantalum powder having an average particle diameter of 0.4 μm obtained by reducing potassium fluorotantalate with sodium was used instead of the tungsten powder in Example 4 and Comparative Example 1;
the calcination temperature and the sintering temperature were set to 1,240° C. and 1,360° C., respectively; and
the anode body had a mass of 40±2 mg deriving from the powder.

Table 1 shows the capacitance and LC values of the solid electrolytic capacitor elements produced in Examples 1 to 9, Comparative Examples 1 to 5 and Reference Examples 1 to 2 and the LC values measured 30 days after the elements were left to stand at room temperature. The capacitance is the value measured at room temperature, 120 Hz and bias voltage of 2.5 V by using an LCR meter manufactured by Agilent, which was measured immediately after the elements were dried at 100° C. for five minutes. The LC value was measured 30 seconds after a voltage of 2.5 V was applied. The concentrations of phosphorus and boron in the tungsten granulated powder were determined by ICP emission spectrometry, the nitrogen amount and oxygen amount were determined by LECO analysis. The capacitance and LC values are the average value of arbitrary-selected 40 pieces of the elements in each examples. The analysis values with respect to phosphorus, boron, oxygen and nitrogen are the average value of 2 pieces per example.

TABLE 1

| | | Phosphorus | | | |
|---|---|---|---|---|---|
| | Phosphorus- | element content | Initial | | LC after being |
| | containing | in the anode body | capacitance | Initial LC | left to stand |
| | compound | (ppm by mass) | μF | μA | μA |
| Example 1 | Phosphoric acid | 19 | 328 | 55 | 67 |
| Example 2 | Same as above | 54 | 323 | 50 | 54 |
| Example 3 | Same as above | 396 | 331 | 54 | 60 |
| Example 4 | Same as above | 1962 | 318 | 48 | 53 |
| Example 5 | Same as above | 2948 | 335 | 65 | 80 |
| Comparative | Same as above | 0 | 310 | 54 | 168 |
| Example 1 | | | | | |
| Comparative | Same as above | 13 | 335 | 51 | 174 |
| Example 2 | | | | | |
| Comparative | Same as above | 3159 | 348 | 147 | 159 |
| Example 3 | | | | | |
| Example 6 | Ammonium | 27 | 320 | 58 | 71 |
| | phosphate | | | | |
| Example 7 | Same as above | 86 | 324 | 44 | 50 |
| Example 8 | Same as above | 1034 | 336 | 57 | 62 |
| Example 9 | Same as above | 2068 | 319 | 52 | 65 |
| Comparative | Same as above | 0 | 327 | 56 | 182 |
| Example 4 | | | | | |
| Comparative | Same as above | 3271 | 340 | 183 | 202 |
| Example 5 | | | | | |
| Example 10 | Phosphoric acid | 372 | 326 | 46 | 52 |
| Example 11 | Same as above | 408 | 339 | 54 | 63 |
| Example 12 | Same as above | 530 | 309 | 47 | 54 |
| Example 13 | Same as above | 316 | 294 | 50 | 56 |
| Reference | Phosphoric acid | 1074 | 214 | 13 | 15 |
| Example 1 | | | | | |
| Reference | Same as above | 0 | 206 | 16 | 18 |
| Example 2 | | | | | |

When Examples and Comparative Examples are compared, it can be seen that the initial LC value and the rise in the LC value after the elements were left to stand can be significantly suppressed by allowing the anode body to contain phosphorus in the amount of 15 to 3,000 ppm by mass. The degree of reduction is particularly remarkable when the phosphorus concentration is 50 to 2,000 ppm by mass. Also, in Reference Examples in which a tantalum anode body was used, it can be seen that there is no effect of phosphorus and almost no deterioration due to the standing property is caused in the case of a tantalum solid electrolytic capacitor element.

Furthermore, when an anode body is produced using a granulated powder obtained by mixing tantalum powder in tungsten powder added with phosphorus (Examples 12 to 13), it can be seen that the rise in the LC values can be kept as low as 1.1 to 1.2 times as the standing property of the solid electrolytic capacitor elements using the anode body.

### INDUSTRIAL APPLICABILITY

The standing property (deterioration in the LC value) can be significantly improved by incorporating 15 to 3,000 ppm of phosphorus element in the sintered body of tungsten powder serving as an anode body in a solid electrolytic capacitor element, and a high-capacitance solid electrolytic capacitor using a tungsten capacitor element can be provided at a low cost.

1. An anode body for a capacitor comprising a tungsten sintered body containing 15 to 3,000 ppm by mass of phosphorus element.

2. The anode body as claimed in claim 1, further comprising 7 mass % or less of silicon element.

3. The anode body as claimed in claim 2, wherein the silicon element is contained as tungsten silicide.

4. The anode body as claimed in claim 1, in which an oxygen element content is 8 mass % or less.

5. The anode body as claimed in claim 1, in which a nitrogen element content is 0.5 mass % or less.

6. The anode body as claimed in claim 1, in which a boron element content is 0.1 mass % or less.

7. The anode body as claimed in claim 1, in which each content of impurity elements other than phosphorus, silicon, boron, oxygen and nitrogen is 0.1 mass % or less.

8. The anode body for a capacitor as claimed in claim 1, in which each amount of impurity elements other than silicon, nitrogen, boron, oxygen, phosphorus, tantalum and niobium is 1,000 ppm by mass or less.

9. A method for producing an anode body comprising phosphorus element for a capacitor in a method for producing an anode body for a capacitor comprising sintering a molded body of tungsten powder, which method comprises producing a molded body of tungsten powder in which a phosphorus source is mixed and sintering the molded body to thereby incorporate 15 to 3,000 ppm by mass of phosphorus element in the anode body.

10. The method for producing an anode body for a capacitor as claimed in claim 9, wherein the phosphorus source is selected from elemental phosphorus, phosphoric acid, phosphate and organic phosphorus compound.

11. The method for producing an anode body for a capacitor as claimed in claim 9, wherein the tungsten powder contains at least one element selected from a group consisting of silicon, nitrogen, oxygen and boron.

12. A capacitor element comprising an anode body as claimed in claim 1.

13. A capacitor comprising the capacitor element claimed in claim 12.

14. A capacitor element comprising an anode body obtained by the method as claimed in claim 9.
